(19) United States
(12) Patent Application Publication
(10) Pub. No.: US 2026/0164323 A1
(43) Pub. Date: Jun. 11, 2026

(54) METHODS PERFORMED BY NETWORK NODE AND NODE, AND NODE DEVICE

(71) Applicant: Samsung Electronics Co., Ltd., Suwon-si, Gyeonggi-do (KR)

(72) Inventors: Weiwei WANG, Beijing (CN); Hong WANG, Beijing (CN); Lixiang XU, Beijing (CN); Yu PAN, Beijing (CN)

(21) Appl. No.: 19/126,068

(22) PCT Filed: Nov. 2, 2023
(86) PCT No.: PCT/KR2023/017400

§ 371 Date: Apr. 30, 2025

(30) Foreign Application Priority Data
Nov. 2, 2022 (CN) 202211364786.6
Aug. 9, 2023 (CN) 202311002341.8

(51) Int. Cl. H04W 36/08; H04W 36/00

(52) U.S. Cl. CPC H04W 36/08; H04W 36/0061

(57) ABSTRACT

The disclosure relates to a 5G or 6G communication system for supporting a higher data transmission rate. The present application provides a method performed by a first network node in a communication system. The method may include: transmitting a first message to a second network node, and transmitting a third message and/or a fourth message to a first node, wherein, the first message is used for indicating to the second network node a candidate cell or cell group configured and/or a candidate cell or cell group selected for the first node, and indicating configuration information of a reference signal of each candidate cell or cell group; the third message is used for at least one of: configuring a candidate cell or cell group of the first node, and configuring the first node to measure the candidate cell or cell group; and the fourth message is used for indicating the first node to perform handover or cell group switch.

### TECHNICAL FIELD

The present disclosure generally relates to a field of communications.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre- 5G communication system. Therefore, the 5G or pre- 5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

An aspect of the disclosure is to provide an apparatus and a method thereof in which, when handover is performed, signaling overhead is reduced and the problem of wasted resources of the cells is solved.

### Solution to Problem

According to an aspect of the present disclosure, there is provided a method performed by a first network node in a communication system. The method may include: transmitting a first message to a second network node, and transmitting a third message and/or a fourth message to a first node, wherein, the first message may be used for indicating to the second network node a candidate cell or cell group configured and/or a candidate cell or cell group selected for the first node, and indicating configuration information of a reference signal of each candidate cell or cell group; the third message may be used for at least one of: configuring a candidate cell or cell group of the first node, and configuring the first node to measure the candidate cell or cell group; and the fourth message may be used for instructing the first node to perform handover or cell group switch.

In some implementations, in the method performed by the first network node, the first message may further be used for requesting the second network node for configuration information of the candidate cell or cell group related to handover of the first node.

In some implementations, in the method performed by the first network node, the candidate cell or cell group may be a cell or cell group served by the second network node, and/or a cell or cell group served by another network node.

In some implementations, in the method performed by the first network node, the first message may include at least one of: first request indication information for indicating a requested cell or cell group, and first configuration indication information.

In some implementations, in the method performed by the first network node, the first request indication information may include at least one of: first reference configuration information, third indication information for indicating whether the second network node needs to admit a bearer, fourth indication information for indicating that information included in the first request indication information is used to configure a candidate cell or cell group, and first measurement configuration indication information.

In some implementations, in the method performed by the first network node, the first request indication information may further include at least one of: first cell identity information, first cell index information, first secondary cell indication information, first cell group identity information, and first bearer request indication information.

In some implementations, in the method performed by the first network node, the first configuration indication information may include at least one of: first configuration identity information, second cell identity information, second cell index information, second secondary cell indication information, second cell group identity information, second bearer configuration indication information, second cell configuration information, and second reference configuration information.

In some implementations, the method performed by the first network node may further include: receiving a second message from the second network node, wherein the second message may include configuration information for configuring the first node.

In some implementations, in the method performed by the first network node, the second message may include at least one of: first response indication information for indicating a cell or cell group admitted or not admitted by the second network node, and fourth measurement configuration indication information.

In some implementations, in the method performed by the first network node, the first response indication information may include at least one of: third cell identity information, third cell index information, third secondary cell indication information, third cell group identity information, third bearer response indication information, third cell configuration information, third serving cell configuration information, and third measurement configuration indication information.

In some implementations, in the method performed by the first network node, the first measurement configuration indication information or the fourth measurement configuration indication information or the third measurement configuration indication information may include at least one of: first configuration identity information, first target indication information, first signal information, and first signal measurement indication information.

In some implementations, in the method performed by the first network node, the first target indication information may include at least one of: node identity information, cell identity information, and frequency point indication information; and/or the first signal information may include at least one of: first signal configuration identity information, first signal type indication information, first resource information, first cell timing information, first beam configuration information, first sequence information, first valid time information, and configuration information for SSB Measurement Timing Configuration (SMTC); and/or the first signal measurement indication information may include at least one of: first signal measurement indication identity information, first time indication information, first signal type indication information, and first condition indication information.

In some implementations, in the method performed by the first network node, the first condition indication information may include at least one of: first condition identity information, a first threshold, a second threshold, a third threshold and/or a fourth threshold, first state indication information, first duration length information, and first counting information.

In some implementations, in the method performed by the first network node, the third message may include at least one of: first serving cell configuration information, first candidate cell configuration information, and fourth reference configuration information.

In some implementations, in the method performed by the first network node, the first serving cell configuration information may include at least one of: first reference configuration indication information, first reservation indication information for indicating the first node to reserve configuration information, and first reservation configuration information, and the first reservation configuration information is used for indicating a condition for reserving configuration information indicated by the first reference configuration indication information.

According to another aspect of the present disclosure, there is provided a method performed by a second network node in a communication system. The method may include: receiving a first message from a first network node; and transmitting a fourth message to a first node; wherein, the first message is used for indicating the second network node a candidate cell or cell group configured and/or a candidate cell or cell group selected for the first node, and indicating configuration information of a reference signal of each candidate cell or cell group, and the fourth message is used for instructing the first node to perform handover or cell group switch.

In some implementations, the method performed by the second network node may further include: transmitting a second message to the first network node, wherein, the second message may include configuration information for configuring the first node.

According to another aspect of the present disclosure, there is also provided a method performed by a first node in a communication system. The method may include: receiving a third message from a first network node; and/or receiving a fourth message from the first network node and/or a second network node, wherein, the third message may be used for at least one of: configuring a candidate cell or cell group of the first node, and configuring the first node to measure the candidate cell or cell group; and the fourth message may be used for indicating the first node to perform handover or cell group switch.

According to another aspect of the present disclosure, there is also provided a node device. The node device includes: a transceiver, for transmitting and receiving a signal; and a controller, coupled to the transceiver and configured to execute the above-described method performed by at least one of the first network node, the second network node, and the first node.

According to another aspect of the present disclosure, there is also provided a non-transitory computer-readable medium having stored thereon instructions which, when executed by a controller and/or a processor of a device, cause the device to execute the above-described method performed by at least one of the first network node, the second network node, and the first node.

### Advantageous Effects of Invention

Methods and apparatuses for efficiently performing a handover in a wireless communication system are provided.

### BRIEF DESCRIPTION OF DRAWINGS

FIG. 1 illustrates an exemplary system architecture of system architecture evolution (SAE).

FIG. 2 illustrates an exemplary system architecture according to various embodiments of the present disclosure.

FIG. 3 illustrates a first example process of interaction between nodes according to various embodiments of the present disclosure.

FIG. 4 illustrates a second example process of interaction between a node and a user equipment according to various embodiments of the present disclosure.

FIG. 5 illustrates a third example process of interaction between a node and a user equipment according to various embodiments of the present disclosure.

FIG. 6 illustrates a fourth example process of interaction between a node and a user equipment according to various embodiments of the present disclosure.

FIG. 7 illustrates a block diagram of a node according to an exemplary embodiment of the present disclosure.

FIG. 8 illustrates a block diagram of a user equipment according to an exemplary embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

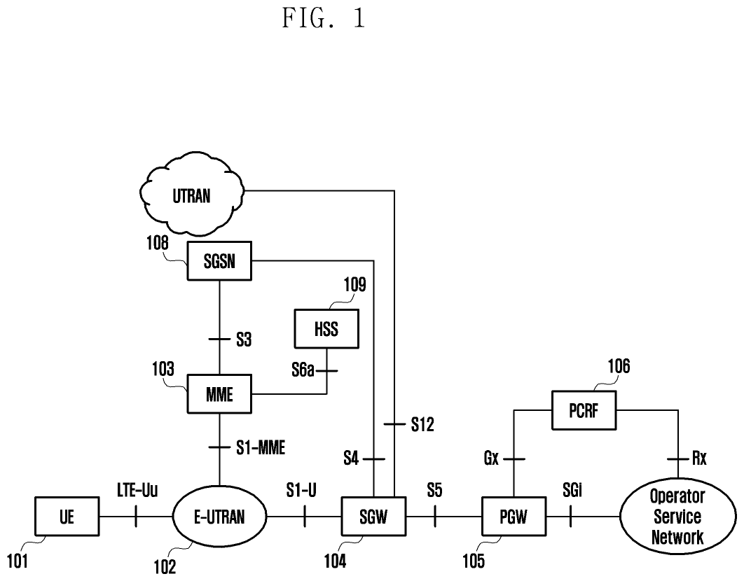

FIGS. 1 to 8 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

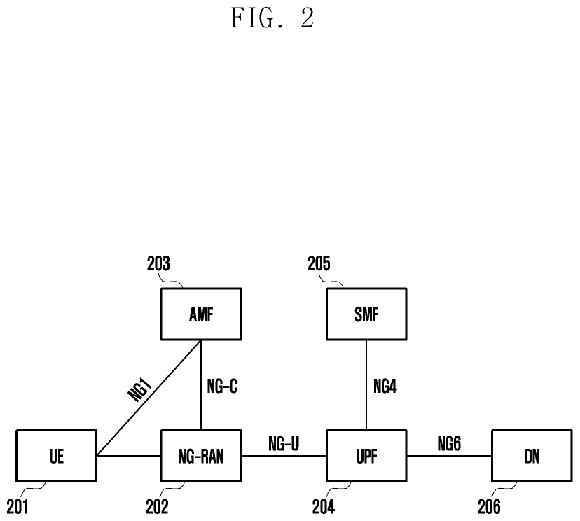

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

In a mobile network, a user equipment (UE) will be handed over between different cells. A major problem caused by handover is that the UE will experience communication interruption during this process. A main reason for the interruption is that the UE needs to perform a relative long time measurement. Before the handover, a network side needs to perform signalling interaction between different nodes to determine a target cell and configuration of the target cell, and then send a handover command to the UE. After that, the UE also needs to perform uplink and downlink synchronization with the network. During this process, it takes a long time for the UE to switch cells, which further affects performance of the UE during a moving process.

Before specific contents are introduced, some assumptions and some definitions of the present disclosure are given below.
Message and/or information names in the present disclosure are merely examples, and other message and/or information names may also be used.
“First”, “second” and so on included in the message names in the present disclosure are merely used for distinguishing one message from another message, but do not denote execution order.

In the present disclosure, the detailed description of irrelevant steps to the present disclosure is omitted.

In the present disclosure, the step in each flow may be combined with each other for execution, or may be executed separately. The execution order of steps in each flow is merely exemplary, other possible execution orders are not excluded.
In the present disclosure, a base station may be a 6G base station or 5G base station (such as a gNB, an ng-eNB), or may be a 4G base station (such as an eNB), or may be other types of access nodes.
In the present disclosure, when a cell accessed by the UE changes from one cell to another, this behavior can be called handover or cell switch. In the following description, the handover and the cell switch have the same meaning. When a cell group accessed by the UE changes from one cell group to another cell group, this behavior may be referred to as cell group handover or cell group switch. In the following description, the cell group handover or the cell group switch have the same meaning.
In the present disclosure, a cell admission indicates to admit to set up/add/modify a cell. A bearer admission indicates to admit to set up/add/modify a bearer.

Nodes involved in the present disclosure include:
A first node, which is a user equipment, for example, the device may be a mobile phone, or a relay node, or the like
A second node, which is a central unit of a base station, or a control plane portion of the central unit of the base station
A third node, which is a distributed unit of the base station
A fourth node, which is a first base station, or a central unit of the first base station, or a control plane portion of the central unit of the first base station
A fifth node, which is a second base station, or a central unit of the second base station, or a control plane portion of the central unit of the second base station

The base stations involved in the above-mentioned second node, third node, fourth node, and fifth node may be one of the following types (not excluding other types that may be used for user equipment to access):
Long Term Evolution (LTE) base station
5G base station
6G base station
Non-Terrestrial Networks (NTN) base station
High Altitude Platform Station (HAPS) base station
Drone base station
WIFI access point

During the moving process of the user equipment, it will start handover (cell switch) according to signalling of the network side. In order to speed up the handover process of the user equipment, the signalling of the network side can be a signalling from a lower layer (a layer 1 signalling, such as a physical layer signalling, downlink control information; a layer 2 signalling, such as a media access control (MAC) layer signaling, a MAC control element (MAC CE)). Further, the network side may allow the user equipment to continuously switch between different cells configured for the user equipment by continuously transmitting the lower layer signalling without recon-figuring the user equipment. An advantage of doing so is to avoid a procedure of first configuring and then handover during the handover process, and reduce a latency of the handover of the user equipment. However, when the target cell to be handed over by the user equipment is in a different node (such as a different distributed unit or a different base station), the user equipment cannot quickly hand over between cells belonging to different nodes according to the lower layer signalling, so it can only rely on layer 3 signalling (such as radio link control (RRC)) for handover, resulting in an increase in handover latency. Therefore, it is necessary to enhance the handover process of the user equipment, for example, how to enhance the user equipment to perform handover based on the lower layer signalling between cells of different nodes is an urgent problem to be solved.

In order to implement the user equipment's handover between cells (or continuous handover between multiple cells) according to the lower layer signalling, a serving base station (or a central unit of the base station, or a control plane portion of the central unit of the base station) of the user equipment configures one or more candidate cells for the user equipment, and these candidate cells may belong to the same node (such as the same base station, or the same distributed unit of a base station), or may belong to different nodes (such as different base stations, or different distributed units of a base station, or distributed units of different base stations). In the present disclosure, in order to solve the above technical problem, when the user equipment hands over between different distributed units, the central unit of the base station will notify the distributed unit assessed by the user equipment of a candidate cell or cell group configured for the user equipment; when the handover of the user equipment occurs between different base stations, the base station that configures a candidate cell or cell group for the user equipment will notify other base stations of the configured candidate cell or cell group. A beneficial effect of the above solution is that: the distributed unit of the base station or the base station can know the candidate cell or cell group configured for the user equipment, and thereby can continuously transmit the handover signalling to the user equipment (such as the lower layer signalling, layer 1 and/or layer 2 signalling), and then complete fast handover between different nodes and reduce the handover latency; on the other hand, after learning the candidate cell or cell group configured for the user equipment, it can help the node serving the user equipment to generate related configurations, in order to help the serving node make a decision on the handover of the user equipment.

In the description hereinafter, the following possible configuration information will be used:
Measurement configuration information, which mainly configures the user equipment to perform signal measurement (the measurement can be a layer 1 or layer 2 measurement, and the measurement can be the same frequency measurement or different frequency measurement). The information may be given separately for different nodes, or for different frequency points, or for different cells or cell groups. The information may include at least one of:
First configuration identity information, which identifies a configuration required by the first node for signal measurement. The configuration indicated by the identity information may be one or more of the configuration information included in the “measurement configuration information”
First target indication information, which indicates information of a target signal measured by the first node. The information may include at least one of:
Node identity information. A node indicated by the information is a node where a signal measured by the first node is located. In an embodiment, the node indicated by the information is a node that the first node may access (a node where the candidate cell is located)
Cell identity information. A cell indicated by the information is a cell where the signal measured by the first node is located. In an embodiment, the cell identified or indicated by the information may be a cell (a candidate cell) to be accessed by the first node
Frequency point indication information. A frequency point indicated by the information is a frequency point where the signal measured by the first node is located. In an embodiment, the information indicates information of a frequency point where a serving cell (a candidate cell) of node that the first node may access is located. The information may include at least one of: location indication information of a centre frequency point, and indication information of a frequency band range
First signal information, which indicates configuration information of the signal needs to be measured by the first node. Further, the signal indicated by the information may be a signal in the cell indicated by the above-mentioned “cell identity information”, or the signal indicated by the information may be a signal in a cell on a frequency point indicated by the above-mentioned “frequency point indication information”. For a type of signal, the information may include at least one of:
First signal configuration identity information, which identifies a set of configurations of the signal measured by the first node
First signal type indication information, which indicates the type of the signal measured by the first node. For the signal type indicated by the information, please refer to the following description about “signal type”
First resource information, which indicates a resource used by the measured signal. The information may include at least one of:
First frequency-domain resource information, which indicates a location of a frequency domain where the signal is located. In an embodiment, the location may be indicated by a frequency point and a bandwidth. In another embodiment, the location may be indicated by an identity of the frequency-domain resource, such as an identity of the range of the frequency-domain resource. In another embodiment, the location may be indicated by an identity of a frequency band, such as an identity of a bandwidth part (BWP) or an identity of a sub-band. In another embodiment, the frequency domain resource may be given by configuration information of the BWP. Further, the user equipment should be able to measure a signal of a non-serving cell (such as a synchronization signal block (SSB)) in the configured BWP
First time-domain resource information, which indicates a location of a time domain where the signal is located. In order to indicate the location, the information may include at least one of:
C Cycle
Offset
Serial numbers of time units (such as serial numbers of time slots, serial numbers of symbols)
Time length
Starting time, which indicates time to start measuring the signal
First cell timing information, which may indicate an offset of timing between different cells (such as an offset of system frame number). The offset may be relative to a current serving cell of the user equipment
First beam configuration information, which indicates a beam required for signal measurement. The information may include at least one of: Transmission configuration indicator (TCI) state indication information, beam identity information, receiving beam precoding information, and transmitting beam precoding information, etc
First sequence information, which indicates a sequence used by the first node for signal measurement
First valid time information, which indicates a valid time of the configuration information included in the above-mentioned “first signal information”. If the valid time is exceeded, these configuration information will no longer be valid, and the first node will not be able to use these configuration information for the signal measurement
SSB Measurement Timing Configuration (SMTC) information, which gives configuration information of the SSB of the cell, such as a cycle, an offset, a measurement duration, physical cell identity (PCI) indication information, and SSB location information, etc
First signal measurement indication information, which indicates configuration information required by the first node for signal measurement. A beneficial effect of the information is that the first node can perform signal measurement according to the information, to avoid unnecessary measurement of the user equipment, and reduce energy consumption of the measurement of the user equipment. The information may include at least one of:
First signal measurement indication identity information, which identifies a set of configurations for the first node to perform signal measurement
First time indication information, which indicates a time range for the first node to perform signal measurement. The information may be named as measurement gap, accessing gap, transmission/reception period, etc. Further, the information may be different due to different types of signals that the first node needs to measure, or the information may be different due to different conditions that the first node meet. The information may include at least one of:
Cycle
Offset
Serial numbers of time units (such as serial numbers of time slots, serial numbers of symbols)
Time length (the time length indicates a time length for the first node to perform signal measurement. In an embodiment, the length may be represented by a time unit, such as millisecond, microsecond, second, etc. In another embodiment, the time length may be represented by the number of symbols.)
Starting time (the information indicates time for the first node to start signal measurement)
First signal type indication information, which indicates the type of the signal measured by the first node. For the signal type indicated by the information, please refer to the following description about “signal type”. Further, the information may indicate the type of the signal measured within the time range indicated by the above “first time indication information”. A beneficial effect of the information is that the first node can determine the signal that it needs to measure according to the information, to avoid that the first node performs measurement in unnecessary time, or the measured signal is incorrect, and reduce energy consumption of signal measurement or interruption of communication
First condition indication information, which indicates a condition for the first node to perform signal measurement. The information indicates a condition that the first node needs to meet when measuring the signal. A beneficial effect of the information is: the first node can perform signal measurement only when the condition is met, to avoid that the first node performs measurement in unnecessary time, or the measured signal is incorrect, and reduce the energy consumption of signal measurement or the interruption of communication. The information may include at least one of:
First condition identity information, which identifies one of the conditions for the first node to perform signal measurement (such as at least one of the following conditions 1 to 6)
First threshold. This information indicates a threshold used in condition 1 for the first node to perform signal measurement. The condition 1 is “a measurement result of the signal of the serving cell exceeds (greater than or equal to) the first threshold”, and the measurement result may be at least one of Reference Signal Received Power (RSRP) of layer 3, Reference Signal Receiving Quality (RSRQ) of layer 3, Signal to Interference plus Noise Ratio (SINR) of layer 3, RSRP of layer 1, RSRQ of layer 1, SINR of layer 1, Channel Quality Indicator (CQI), etc
Second threshold. This information indicates a threshold used in condition 2 for the first node to perform signal measurement. The condition 2 is “a difference between a measurement result of the signal of the serving cell (the cell is a cell serving the first node, or a primary cell (PCell) serving the first node, or a primary secondary cell (or primary secondary cell group cell, or PSCell) serving the first node, or a special primary cell (SpCell) serving the first node) and a measurement result of the signal of another cell is less than or equal to the second threshold”, and the measurement result may be at least one of RSRP of layer 3, RSRQ of layer 3, SINR of layer 3, RSRP of layer 1, RSRQ of layer 1, SINR of layer 1, CQI, etc
Third threshold and/or fourth threshold. This information indicates a threshold used in condition 3 for the first node to perform signal measurement. The condition 3 is “a measurement result of the signal of the serving cell (the cell is a cell serving the first node, or a primary cell (PCell) serving the first node, or a primary secondary cell (or primary secondary cell group cell, or PSCell) serving the first node, or a special primary cell (SpCell) serving the first node) is less than or equal to the third threshold, and/or a measurement result of a signal of another cell is greater than or equal to the fourth threshold”
First state indication information, which indicates a state used in condition 4 for the first node to perform signal measurement. The condition 4 is the state in which the first node performs signal measurement, and this information can indicate at least one of the following states:
A cell/node/frequency point is not found. In an embodiment, the configured cell/node/frequency point is not found by the first node
A cell/node/frequency point is found
Not synchronized in the downlink. This state indicates that the first node has not yet been synchronized in the downlink
First synchronization in the downlink. In an embodiment, the first node receives a first synchronization signal (such as an SSB, a Primary Synchronization Signal (PSS)/Secondary Synchronization Signal (SSS)) for the downlink, such as completing a coarse downlink synchronization
Downlink synchronization. In an embodiment, the first node receives a second synchronization signal (such as a cell reference signal, a tracking RS) for the downlink. In another embodiment, the first node receives the first synchronization signal for the downlink and the second synchronization signal for the downlink
Transmitting an uplink random access signal. If the base station receives the random access signal, the base station will generate a configuration to help the first node perform uplink synchronization (such as timing advance information). In an embodiment, the first node sends a random access preamble
Uplink synchronization. In an embodiment, the first node completes uplink synchronization with other cells that are different from the cell serving the first node (or the primary cell, or the special primary cell)
Uplink and downlink synchronization. In an embodiment, the first node completes uplink and downlink synchronization with other cells that are different from the cell serving the first node (or the primary cell, or the special primary cell)
First duration length information, which indicates information used in condition 5 for the first node to perform signal measurement. The condition 5 indicates the duration required for the first node to meet at least one of the above conditions 1 to 4
First counting information, which indicates the information used in condition 6 for the first node to perform signal measurement. The condition 6 is the number of times the first node needs to meet at least one of the above conditions 1 to 4

The type of signal measured corresponding to the above-mentioned “measurement configuration information” (herein referred to as “signal type” for short) may be at least one of the following signal types:
Downlink reference signal (DL reference signal), such as a cell RS, a tracking RS, a channel state indication RS
Downlink synchronization signal, such as at least one of a synchronization signal block (SSB), a reference signal, a tracking reference signal, a channel state information reference signal (CSI-RS) (the CSI-RS may have different purposes, such as tracking, beam management, mobility, etc.), a newly-defined signal for downlink synchronization (such as a fast downlink synchronization signal), and the like. The above signals may be used to perform first synchronization for the downlink (coarse synchronization), or may be used to perform second synchronization for the downlink (fine synchronization)
Uplink synchronization signal, such as at least one of a random access signal, a sounding reference signal (SRS), a newly-defined signal for uplink synchronization (such as a fast uplink synchronization signal), etc

In order to realize the above solution, the present disclosure provides the following process.

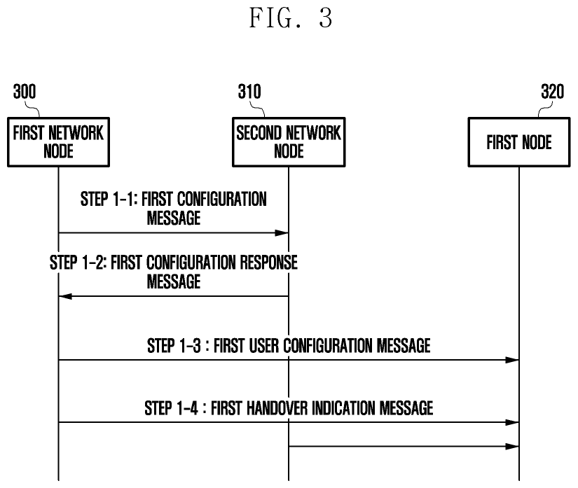

FIG. 3 illustrates a first example process of interaction between nodes according to various embodiments of the present disclosure.

The first network node 300 and the second network node 310 in this process may be the above-mentioned second node and third node, or the fourth node and the fifth node, respectively:
Step 1-1: the first network node 300 transmits a first message to the second network node 310.

In an implementation, the first message may be a first configuration message, and a function of the message is at least one of the following: 1) requesting for configuration information of a candidate cell or cell group (for example, related to the handover of the first node), to help the first network node decide the candidate cell or cell group configured for the user equipment, 2) indicating a candidate cell or cell group configured (or selected) for the user equipment, so as to facilitate the second network node 310 indicating the user equipment to perform fast handover or cell group switch, which reduces the latency of the user equipment in the process of switching or changing the cell group, 3) helping the second network node 310 generate user equipment configuration information according to the configured candidate cell (or candidate cell group, or selected candidate cell, or selected candidate cell group), which facilitates the user equipment measuring the candidate cell or cell group, discovering the candidate cell or cell group in time, and reducing the handover latency.

The message may include at least one of the following information:
First request indication information, which indicates cells or cell groups requested by the first network node 300. In an embodiment, the “requested cells or cell groups” may be candidate cells, or a candidate cell list, or candidate cell groups, or a candidate cell group list that the first network node 300 requests to configure for the user equipment (but not yet configured for the user equipment). The second network node 310 can determine whether to accept these “requested cells or cell groups” according to its own conditions (such as load, etc.), and generate configuration information of these “requested cells or cell groups”. The first request indication information will contain one or more cells (these cells may belong to the same cell group, or belong to different cell groups) or cell groups. In an embodiment, the cells or cell groups are cells or cell groups served by the second network node 310. For a cell or cell group, the information may include at least one of:
First cell identity information, such as a Physical Cell Identity (PCI), a NR Cell Global Identifier (NCGI), an E-UTRAN Cell Global Identifier (ECGI)), etc. In an embodiment, the cell indicated by the information may be a primary cell in a cell group (such as a special primary cell SpCell, a primary cell PCell in a master cell group, or a primary secondary cell PSCell in a secondary cell group)
First cell index information, which indicates the index information of the cell. Identity information of the cell can be obtained according to this information. In an embodiment, the cell indicated by this information can be a primary cell in a cell group (such as a special primary cell SpCell, a primary cell PCell in a master cell group, or a primary secondary cell PSCell in the secondary cell group)
First secondary cell indication information, which indicates one or more secondary cells. These secondary cells are cells located at the same cell group as the cell indicated by the above “first cell identity information” and/or “first cell index information”. For a secondary cell, the indication information may include at least one of the cell identity and the cell index information
first cell group identity information, such as a cell group ID. In an embodiment, the cell group identified by the information includes the cells identified by the above “first cell identity information” and/or “first cell index information”, and optionally, may also include one or more secondary cells identified by the above-mentioned “first secondary cell indication information”
First reference configuration information, which indicates a configuration that the second network node 310 needs to refer to when generating the configuration of the user equipment (in an embodiment, the configuration of the user equipment may be the configuration for the cell indicated by the above “first cell identity information”, or the configuration for the cell group where the cell indicated by the “first cell identity information” is located, such as CellGroupConfig). The configuration may be the configuration of the current serving cell or serving cell group of the user equipment, or may be specific reference configuration information. A beneficial effect of the information is: to help the second network node 310 generate a delta configuration based on the reference configuration, and reduce signalling overhead of the configuration.

The reference configuration may include at least one of the following configurations: 1) a Packet Data Convergence Protocol (PDCP) configuration, 2) a Radio Link Control (RLC) configuration, 3) a MAC configuration, 4) a physical (PHY) configuration, 5) a logical channel configuration, 6) a bearer configuration, etc
First bearer request indication information, which indicates a bearer that requests the second network node 310 to serve. In an embodiment, the information indicates a bearer that the first network node 300 requests the second network node 310 to serve in the cell identified by the above “first cell identity information” and/or “first cell index information” or the cell group where the identified cell is located (optionally, also including one or more secondary cells identified by the above “first secondary cell indication information”), and/or the cell group identified by the above “first cell group identity information”. A beneficial effect of the information is that the second network node 310 can determine whether the bearer can be served according to the information. For a bearer, the information may contain at least one of:
First bearer identity information, such as a signaling radio bearer identity (SRB ID), a data radio bearer identity (DRB ID)
First Quality of Service (QoS) indication information, which indicates parameter settings of the QoS of the bearer
First indication information, which indicates an admission control behavior of the second network node 310 on the bearer identified by the above “first bearer identity information”. As an optional embodiment, the indication information may indicate a behavior when the second network node 310 cannot admit the bearer. In an embodiment, the information indicates whether the bearer identified by the above “first bearer identity information” is allowed to be released (for example, allowed to be released, or not allowed to be released). If the second network node 310 receives the indication information and it indicates “allowed to be released”, then when the second network node 310 cannot admit the bearer, the second network node 310 may notify the first network node 300 that it cannot admit the bearer; if it indicates “not allowed to be released”, when the second network node 310 cannot admit the bearer, the second network node 310 may notify the first network node 300 that the bearer is suspended (in an example, when a bearer is suspended, the first node 320 will reserve the configuration information of the bearer, but will not allocate resources to serve the bearer, that is, stop data transmission and reception on the bearer, such as clear data packets of the bearer in a buffer, suspend the PDCP layer, RLC layer, etc.), and further, it may inform the identity information of the cell or cell group or candidate cell or candidate cell group requested by the first network node 300 that cannot be admitted by the second network node 310. In another embodiment, the information indicates whether the bearer identified by the above “first bearer identity information” is allowed to be suspended (such as allowed to be suspended, or not allowed to be suspended). If the second network node 310 receives the indication information and it indicates “allowed to be suspended”, when the second network node 310 cannot admit the bearer, the second network node 310 may notify the first network node 300 that the bearer is “suspended” (in an example, when a bearer is suspended, the first node 320 will reserve the configuration information of the bearer, but will not allocate resources to serve the bearer, that is, stop the data transmission and reception on the bearer, such as clear the data packets of the bearer in the buffer, suspend the PDCP layer, RLC layer, etc.); if it indicates “not allowed to be suspended”, when the second network node 310 cannot admit the bearer, the second network node 310 may notify the first network node 300 that the bearer cannot be admitted by the second network node 310, and further, it may inform the identity information of the cell or cell group or candidate cell or candidate cell group requested by the first network node 300 that it cannot admit
Suspension time indication information, which indicates a time length that the bearer is allowed to be suspended. If the bearer is suspended for the duration longer than the length indicated by the indication information, then the bearer needs to be released
Second indication information, which indicates whether the above “first bearer identity information” must be admitted. If it must be admitted, when the cell identified by the above “first cell identity information” and/or “first cell index information” of the second network node 310 (optionally, it may also include one or more secondary cells identified by the above “first secondary cell indication information”), and/or the cell group identified by the above “first cell group identity information” cannot admit the bearer indicated by the above “first bearer identity information”, the above cell or cell group cannot be configured to the user equipment as a candidate cell or cell group. Optionally, the second network node 310 will indicate that the cell or cell group is an unadmitted cell or cell group in the following first configuration response message
Third indication information, which indicates whether the second network node 310 needs to admit a bearer of the user equipment (in an embodiment, the bearer may be all or part of the bearers indicated by the above “first bearer request indication information”). If the bearer must be admitted, when the cell identified by the above “first cell identity information” and/or “first cell index information” of the second network node 310 (optionally, it may also include one or more secondary cells identified by the above “first secondary cell indication information”), and/or the cell group identified by the above “first cell group identity information” cannot admit at least one bearer, the above-mentioned cell or cell group cannot be configured to the user equipment as a candidate cell or cell group. Optionally, the second network node 310 will indicate that the cell or cell group is an unadmitted cell or cell group in the following first configuration response message
Fourth indication information. A function of this information is to indicate that the information contained in the above “first request indication information” is used to configure a candidate cell or cell group for handover. Further, the handover can be a layer 1 and/or layer 2 triggered mobility or handover or switch
First measurement configuration indication information, which indicates configuration required by the user equipment for measurement. In an embodiment, the measurement configuration is a configuration required for the user equipment to perform layer 1 and/or layer 2 measurement (optionally, the configuration may be given for different cells or cell groups, or may be given for different frequencies). For content contained in the indication information, please refer to the above “measurement configuration information”
First configuration indication information, which may include configuration information of one or more cells or cell groups. The cells or cell groups indicated in the configuration information may only include cells or cell groups belonging to the second network node 310, or may include both cells or cell groups belonging to the second network node 310 and cells or cell groups belonging to other network nodes. In an optional embodiment, the cells or cell groups included in the configuration information are part or all of selected candidate cells or cell groups (these candidate cells or cell groups may have been configured for user equipment, or will be configured for the user equipment, or will be potentially configured for the user equipment. After receiving the information of these candidate cells or cell groups, the user equipment can hand over between these candidate cells or cell groups according to the signalling of the network). After the second network node 310 receives the information, it can determine the candidate cell or cell group configured for the user equipment, so that when the user equipment needs a handover, a suitable candidate cell or cell group is selected for the user equipment as a target cell or cell group. As an example, the information may be named as a configured candidate cell, a configured candidate cell list, a selected candidate cell, a selected candidate cell list, a potential candidate cell, or a potential candidate cell list, but other names are not excluded. For a cell, the information may include at least one of:
First configuration identity information, which identifies a set of configurations, such as one or more of the following included in the “first configuration indication information”
Second cell identity information, such as a PCI, a NCGI, an ECGI, etc. In an embodiment, the cell indicated by this information can be a primary cell in a cell group (such as a special primary cell SpCell, a primary cell PCell in a master cell group, or a primary secondary cell PSCell in a secondary cell group)
Second cell index information, which indicates the index information of the cell. Identity information of the cell can be obtained according to this information. In an embodiment, the cell indicated by this information can be a primary cell in a cell group (such as a special primary cell SpCell, a primary cell PCell in a master cell group, or a primary secondary cell PSCell in a secondary cell group)
Second secondary cell indication information, which indicates one or more secondary cells. These secondary cells are cells in the same cell group as the cell indicated by the above “second cell identity information” and/or “second cell index information”. For a secondary cell, the indication information may include at least one of the cell identity and the cell index information
Second cell group identity information, such as a cell group ID. In an embodiment, the cell group identified by the information includes the cell identified by the above “second cell identity information” and/or “second cell index information”. Optionally, it may also include one or more secondary cells identified in the above “second secondary cell indication information”
Second bearer configuration indication information, which indicates a bearer configured for the user equipment. In an embodiment, the bearer is a bear served after the user equipment accessing the cell or cell group (optionally, it may also include the secondary cells indicated by the above “second secondary cell indication information”) indicated by the above “second cell identity information” and/or “second cell index information” and/or “second cell group identity information” (in an optional embodiment, the cell or cell group may be a candidate cell or cell group configured for the user equipment for handover). In another embodiment, the bearer indicated by the information may be the bearer of the user equipment served in the current serving cell or cell group. A function of this information is to help the second network node 310 acquire the bearer that can be served by the network after the user equipment accesses a cell or cell group (candidate cell or cell group), and then help the second network node 310 select a suitable cell or cell group as the target cell or cell group for handover (for example, a cell or cell group that can serve more bearers of the user equipment is selected as the target for handover). The information may include at least one of:
Second bearer identity information, such as an SRB ID, a DRB ID
Second bearer state indication information. The bearer state indicated by the information can be at least one of the following states: 1) admitted, 2) not admitted, 3) suspended, 4) released
Identity information of an admitted bearer, such as an SRB ID, a DRB ID
Identity information of a released bearer, such as an SRB ID, a DRB ID
Identity information of a suspended bearer, such as an SRB ID, a DRB ID
Suspension time indication information, which indicates a time length that the bearer identified in the above “identity information of a suspended bearer” is allowed to be suspended. If the bearer is suspended for a duration longer than the length indicated by the indication information, then the bearer needs to be released
Second cell configuration information, which indicates configuration of the cell or cell group indicated by the above “second cell identity information” and/or “second cell index information” and/or “second cell group identity information” (optionally, it may also include the secondary cell indicated by the “second secondary cell indication information”). In an embodiment, the configuration information may include the information included in the above “measurement configuration information”. A function of this information is to help the second network node 310 generate a signal measurement configuration (such as the measurement configuration indicated by the configuration information in the third message below). A beneficial effect of the information is that the second network node 310 can configure the measurement of the user equipment according to the information, so as to help the user equipment to discover a candidate cell and speed up the handover of the user equipment. After receiving the information, the second network node 310 will generate a configuration for the user equipment to perform measurement, and these measurements can help the user equipment discover the target cell or cell group
Second reference configuration information, which indicates configuration that the second network node 310 needs to refer to when generating the configuration of the user equipment (in an embodiment, the configuration of the user equipment may be the configuration for the cell indicated by the above “first cell identity information”, or the configuration for the cell group where the cell indicated by the “first cell identity information” is located, such as CellGroupConfig). The configuration may be the configuration of the current serving cell or serving cell group of the user equipment, or may be a specific reference configuration information. A beneficial effect of the information is: to help the second network node 310 generate a delta configuration based on the reference configuration, and reduce signalling overhead of configuration. The reference configuration may include at least one of the following configurations: 1) a PDCP configuration, 2) an RLC configuration, 3) a MAC configuration, 4) a PHY configuration, 5) a logical channel configuration, 6) a bearer configuration, etc. In an implementation, the information is a new reference configuration configured for the second network node 310. After receiving the reference configuration, the second network node 310 will generate configurations of other cells or cell groups based on the configuration; in another implementation, the information is to update existing reference configuration information stored at the second network node 310, and the updated configuration information will be used by the second network node 310 to generate the configurations of other cells or cell groups

Step 1-2: Optionally, the second network node 310 transmits a second message to the first network node 300. In an implementation, the second message may be a first configuration response message, and a function of the message is to provide configuration information for serving the user equipment to the first network node 300, and/or the second message includes configuration information for configuring the first node 320. The message may include at least one of the following information:
First response indication information, which indicates a cell or cell group admitted by the second network node 310, or may indicate a cell or cell group not admitted by the second network node 310. In an embodiment, the first response indication information may be a response to the above “first request indication information”. The above “admitted cell or cell group” may be a candidate cell or a candidate cell list or a candidate cell group or a candidate cell group list that can be admitted by the second network node 310; further, in an example, the “admitted cell or cell group” is those cells or cell groups that can serve all the bearers of the current user equipment (conversely, if a cell or cell group cannot serve at least one bearer of the user equipment, the “admitted cell or cell group” will not contain the information of the cell or cell group; in one example, the “at least one bearer” is a bearer that is not allowed to be released or a bearer that is not allowed to be suspended as indicated by the “first request indication information” in step 1-1); in another example, the “admitted cells or cell groups” are those cells or cell groups that can serve part of the bearers of the current user equipment (in one example, the part of the bearers is the bearer that is not allowed to be released or the bearer that is not allowed to be suspended as indicated by the “first request indication information” in step 1-1). The above “unadmitted cells or cell groups” are cells or cell groups in which the second network node 310 cannot provide services for the user equipment. Further, in one example, the “unadmitted cells or cell groups” are those cells or cell groups that cannot serve all the bearers of the user equipment. In another example, the “unadmitted cells or cell groups” are those cells or cell groups that cannot serve at least one bearer of the user equipment (the “at least one bearer” may be the bearer indicated in the “first request indication information” in step 1-1, or may be any bearer, that is, as long as a cell or cell group cannot serve at least one bearer of the user equipment, the cell or cell group is an “unadmitted cell or cell group”; in another embodiment, the “at least one bearer” is the bearer that is not allowed to be released or the bearer that is not allowed to be suspended as indicated in the “first request indication information” in step 1-1); the first response indication information will include one or more cells or cell groups; and in an embodiment, the cells or cell groups are cells or cell groups served by the second network node 310. For an admitted (or unadmitted) cell or cell group, the information may include at least one of:
Third cell identity information, such as a PCI, a NCGI, an ECGI, etc. In an embodiment, the cell indicated by this information can be a primary cell in a cell group (such as a special primary cell SpCell, a primary cell PCell in a master cell group, or a primary secondary cell PSCell in a secondary cell group)
Third cell index information, which indicates the index information of the cell. Identity information of the cell can be obtained according to this information. In an embodiment, the cell indicated by this information can be a primary cell in a cell group (such as a special primary cell SpCell, a primary cell PCell in a master cell group, or a primary secondary cell PSCell in a secondary cell group)
Third secondary cell indication information, which indicates one or more secondary cells. These secondary cells are cells located in the same cell group as the cell indicated by the above “third cell identity information” and/or “third cell index information”. For a secondary cell, the indication information may include at least one of the cell identity and the cell index information
Third cell group identity information, such as a cell group ID. In an embodiment, the cell group identified by the information includes the cell identified by the above “third cell identity information” and/or “third cell index information” (optionally, it may also include one or more secondary cells identified in the above “third secondary cell indication information”)
Third bearer response indication information, which indicates an admission control result of the second network node 310 on the bearer. In an embodiment, the bearer corresponding to the information is the bearer indicated by the above “first bearer request indication information”. The information may include at least one of:
Identity information of the bearer
Indication information of the admitted bearer, such as the identity information of the bearer
Indication information of the unadmitted bearer, such as the identity information of the bearer. In an embodiment, the bearer indicated by the indication information is released; in another embodiment, the bearer indicated by the indication information is suspended. For example, when the “first indication information” or “third indication information” contained in the above-mentioned first bearer request indication information indicates that the bearer is not allowed to be released (or is allowed to be suspended), then bearer indicated by the “indication information of the unadmitted bearer” is suspended
Indication information of the suspended bearer, such as the identity information of the bearer. In an embodiment, when the “first indication information” contained in the above-mentioned first bearer request indication information indicates that the bearer is not allowed to be released (or is allowed to be suspended), this information can be used to indicate the suspended bearer
Suspension time indication information, which indicates a time length that the bearer indicated in the above “indication information of the suspended bearer” is allowed to be suspended. If the bearer is suspended for a duration longer than the length indicated by the indication information, then the bearer needs to be released Bearer status information, which indicates the status of a bearer, for example, indicates whether the bearer is suspended
Third cell configuration information, which indicates configuration (such as CellGroupConfig) of the cell or cell group indicated by the above “third cell identity information” and/or “third cell index information” and/or “third cell group identity information” (optional, it may also include the “third secondary cell indication information”). In an embodiment, the information will be transmitted to the user equipment to give the configuration of the candidate cell or cell group of the user equipment; further, the configuration information may be a delta configuration generated according to the above “first reference configuration information” or “second reference configuration information”. If a bearer is suspended, the information may also include indication information that the bearer is suspended (such as identity information of the bearer, suspension indication information)
Third serving cell configuration information, which indicates configuration information of the cell or cell group that is currently serving the user equipment. A function of the information is to update the configuration of the cell or cell group that is serving the user equipment (such as CellGroupConfig)
Third measurement configuration indication information, which indicates configuration required by the user equipment for measurement. The configuration may be an updated configuration generated based on a newly configured candidate cell or cell group. The information can help the user equipment to measure the candidate cell or cell group. For content of the information, please refer to the above “measurement configuration information”, and the information is the measurement configuration performed according to the above “first request indication information”
Fourth measurement configuration indication information, which indicates measurement configuration performed according to the information in the “first configuration indication information” in step 1-1. A beneficial effect of the information is to help configure the user equipment to measure a candidate cell (including a cell that is not located at the same node as the serving cell of the user equipment). For content of the information, please refer to the above “measurement configuration information”

Step 1-3: Optionally, the first network node 300 transmits a third message to the first node 320. In an implementation, the third message may be a first user equipment configuration message, and the message may be transmitted by the first network node 300 to the first node 320 through the second network node 310, or may be transmitted by the first network node 300 to the first node 320 through other nodes, or may be transmitted directly by the first network node 300 to the first node 320. A function of this message is: 1) configuring the candidate cell or cell group of the user equipment, and 2) configuring the user equipment to measure the candidate cell or cell group (such as a layer 1 measurement, a layer 2 measurement). The message may include at least one of the following information:
First serving cell configuration information, which includes configuration information of the current serving cell or cell group of the user equipment, such as CellGroupConfig, configuration in the RRCReconfiguration message, measurement configuration, lower layer measurement configuration, etc. In an embodiment, the information is generated based on the “third serving cell configuration information” /d/ or “third measurement configuration indication information” and/or “fourth measurement configuration indication information” in the above “first response indication information”. When the above “first serving cell configuration information” is a reference configuration, the information may further include at least one of:
First reference configuration indication information, which indicates that the configuration in the above “first serving cell configuration information” is a reference configuration. After the user equipment receives the information, it may reserve the configuration in the “first serving cell configuration information”. Further, a subsequent network can generate new configuration information according to the reference configuration (a delta configuration generated based on the reference configuration), to reduce the signalling of the configuration of the user equipment, and the user equipment will generate a final configuration according to the reserved reference configuration and the new configuration information
First reservation indication information, which indicates that the user equipment needs to reserve the configuration (reference configuration) in the above “first serving cell configuration information”. After the user equipment receives the information, it may reserve the configuration in the “first serving cell configuration information”. Further, a subsequent network can generate new configuration information according to the reference configuration (a delta configuration generated based on the reference configuration), to reduce the signalling of the configuration of the user equipment, and the user equipment will generate the final configuration according to the reserved reference configuration and the new configuration information
First reservation configuration information, which indicates a condition for reserving the configuration (reference configuration) in the above “first serving cell configuration information”. The condition may be a time length (for example, in an implementation, if the “time length” is exceeded, then the configuration (reference configuration) in the above “first serving cell configuration information” will no longer be reserved), or the condition may be an event (for example, after the event occurs, it will be reserved or not reserved), and a possible event is a handover to a specific target cell, and the measurement result is greater than or less than a certain threshold
First candidate cell configuration information, which includes information for configuring one or more candidate cells or cell groups for the user equipment, such as CellGroupConfig, configuration in the RRCReconfiguration message. In one example, the information may include information related to the admitted and/or suspended bearer for each candidate cell or cell group (such as identity information of the bearer, configuration information of an RLC entity, configuration information of a PDCP entity, configuration information of a logical channel). Further, the information may also be used to indicate the suspended bearer (further, it may also be used to indicate a time length that each suspended bearer is allowed to be suspended. When a bearer is suspended for a duration longer than the time length, the first node 320 can release the bearer and configuration related to the bearer, such as the configuration of the RLC entity, the configuration of the PDCP entity, and the configuration of the logical channel). specifically, for a candidate cell or cell group, the information may indicate identity of the suspended bearer after the user equipment accesses the candidate cell or cell group (in an example, when a bearer is suspended, the first node 320 will reserve the configuration information of the bearer, but will not allocate resources to serve the bearer, that is, stop the data transmission and reception on the bearer, such as clear the data packets of the bearer in the buffer, suspend the PDCP layer, RLC layer, etc.). In an embodiment, the information is generated according to the “third cell configuration information” and/or “third measurement configuration indication information” and/or “fourth measurement configuration indication information” in the above “first response indication information”. Further, the information is generated after the first network node 300 interacts with multiple different second network nodes according to the above step 1-1 and step 1-2. After obtaining the information, the user equipment will measure these candidate cells or candidate cell groups, and perform fast handover according to the signalling of the network
Fourth reference configuration information, such as CellGroupConfig, configuration in RRCReconfiguration message, measurement configuration, lower layer measurement configuration, etc. After the user equipment receives the information, it will save it. Further, a subsequent network can generate new configuration information (delta configuration generated based on the reference configuration) according to the reference configuration, to reduce the signalling of configuration of the user equipment, and the user equipment will generate a final configuration according to the reserved reference configuration and new configuration information. Further, the information may also include second reservation configuration information, which indicates a condition for reserving the configuration in the above “fourth reference configuration information”. The condition may be a time length (for example, in an implementation, if the “time length” is exceeded, the configuration in the above “fourth reference configuration information” will no longer be reserved), or the condition can be an event (for example, after the event occurs, it will be reserved or not reserved), and a possible event is a handover to a specific target cell, and the measurement result is greater than or less than a certain threshold

After receiving the above third message, the first node 320 will save the configuration information (such as first stored configuration information, in which, for each candidate cell, the configuration information in the above “first candidate cell configuration information” is included) of each candidate cell in the “first candidate cell configuration information” included in the above third message. When the configuration information of the candidate cell included in the above “first candidate cell configuration information” is a difference/delta configuration information, the first node 320 will further generate a complete configuration of each candidate cell according to the difference/delta configuration information and the above “fourth reference configuration information”, and save the complete configuration of each candidate cell (the stored configuration may be second stored configuration information, in which, for each candidate cell, complete configuration information is included, such as configuration information of the bearer (e.g., a bearer ID, the configuration of the PDCP entity, the configuration of the RLC entity, and the configuration of the logical channel), configuration of an MAC layer, measurement configuration information, and configuration information of a physical layer, etc.), so that the first node 320 obtains the configuration information of each candidate cell in time when switching among different candidate cells.

Step 1-4: Optionally, the first network node 300 or the second network node 310 transmits a fourth message to the first node 320. In an implementation, the fourth message may be a first handover indication message, and a function of the message is to indicate the user equipment to perform handover or cell group switch. The message may be used to indicate the configuration required by the first node 320 for handover, such as the indication information of the target cell, and the identity information of the configuration required for handover to the target cell (the identity information can indicate the configuration required for handover to the target cell).

In the above process, when the first network node 300 and the second network node 310 are respectively the second node and the third node:
The first configuration message may be a UE Context Modification Request message of an F1 interface, a downlink (DL) RRC Message Transfer message, or a newly-defined message;

The first configuration response message may be a UE Context Modification Response message of the F1 interface, or a newly-defined message.

When the first network node 300 and the second network node 310 are respectively the fourth node and the fifth node:

The first configuration message may be a handover request message, a secondary node addition request message, a secondary node modification request message of an Xn/X2 interface, or a newly-defined message;

The first configuration response message may be a handover request acknowledge message, a secondary node addition response message, a secondary node modification response message of the Xn/X2 interface, or a newly-defined message.

The above first user configuration message may be an RRCReconfiguration message, or a newly-defined message.

The above first handover indication message may be a layer 2 message, such as a MAC CE, or a layer 1 signalling, such as a DCI, or a newly-defined layer 2 or layer 1 signalling.

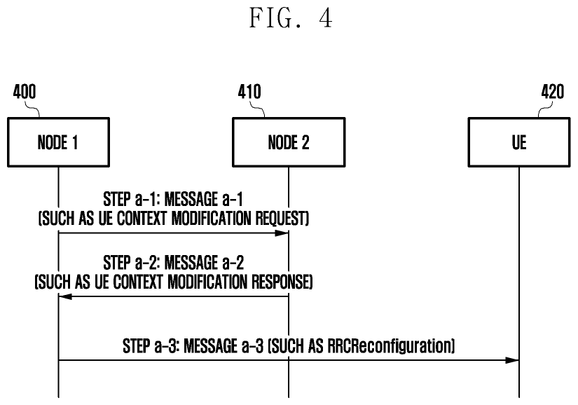

FIG. 4 illustrates a second example process of interaction between a node and a user equipment according to various embodiments of the present disclosure.

The above process may be implemented in the following implementations:
Implementation 1 (a candidate cell is configured, and the configured candidate cell and the current cell belong to the same distributed unit). This implementation involves node 1 and node 2, the node 1 is the central unit of the base station or the control plane portion of the central unit of the base station, the node 2 is the distributed unit of the base station and the distributed unit currently accessed by the user equipment; further, the node 2 is a node to which the candidate cell or cell group of the user equipment belongs. As shown in FIG. 4, this implementation may include the following steps:
Step a-1: the node 1 400 transmits a message a-1 to the node 2 410. A function of the message is that the node 1 400 requests the node 2 410 to configure a candidate cell or cell group for handover of the user equipment 420 (the cell or cell group belongs to the node 2). After receiving the message, the node 2 410 can determine whether the requested candidate cell or cell group can be admitted, and if it can be admitted, the configuration of the candidate cell or cell group and/or the configuration for measuring the candidate cell or cell group will be generated. The message a-1 may include the “first request indication information” in the first configuration message in the above step 1-1
Step a-2: the node 2 410 transmits a message a-2 to the node 1 400. After receiving the message, the node 1 400 can generate a message for configuring the user equipment 420, and the message can configure the candidate cell or cell group of the user equipment 420. The message a-2 may include the “first response indication information” in the first configuration response message in the above step 1-2; and the information may indicate the candidate cell or cell group admitted by the node 2 410, bearers admitted and/or not admitted and/or released and/or suspended by the candidate cell or cell group (such as the above “third bearer response indication information”), configuration information of the candidate cell or cell group (such as the above “third cell configuration information”), configuration information of the serving cell or cell group (such as the above “third serving cell configuration information”), and measurement configuration information (such as the above “third measurement configuration indication information”)
Step a-3: the node 1 400 transmits a message a-3 directly (or via the node 2 410 (not shown)) to the user equipment 420. In the above process, the node 1 400 can know the candidate cells or candidate cell groups configured for the user equipment 420, then the node 1 400 can select a suitable target cell from these candidate cells or cell groups (for example, select according to the measurement results of the candidate cells, and/or admission situations of the bearers by the candidate cells)

In an example, the above message a-1, message a-2 and message a-3 may be respectively a UE Context modification request (a F1 interface message), a UE Context modification response (F1 interface message), an RRCReconfiguration (an RRC message), or a newly-defined message.

Implementation 2 (candidate cells are informed, and the candidate cells may be all or part of the selected (or configured) candidate cells or cell groups)

This implementation involves a node 1 400 and a node 2 410. In an implementation, the node 1 400 is a central unit of a base station (or a control plane portion of the central unit of the base station), and the node 2 410 is a distributed unit of the base station, such as a distributed unit where the current serving cell of the user equipment is located (the user equipment may have accessed the serving cell for a long time, or may have just accessed the serving cell), or a distributed unit where the target cell of the user equipment 420 is located. In another implementation, the node 1 400 is a first base station (or a central unit of the base station, or a control plane portion of the central unit of the base station), such as a base station where the serving cell of the user equipment is located; and the node 2 410 is a second base station (or a central unit of the base station, or a control plane portion of the central unit of the base station), such as a base station where the candidate cell or cell group of the user equipment 420 is located. A main purpose of the implementation 2 is to notify the node 2 410 of the candidate cells or cell groups selected or configured for the user equipment. After receiving the information, the node 2 410 can know which cells can be the target cells of the user equipment 420 for handover.

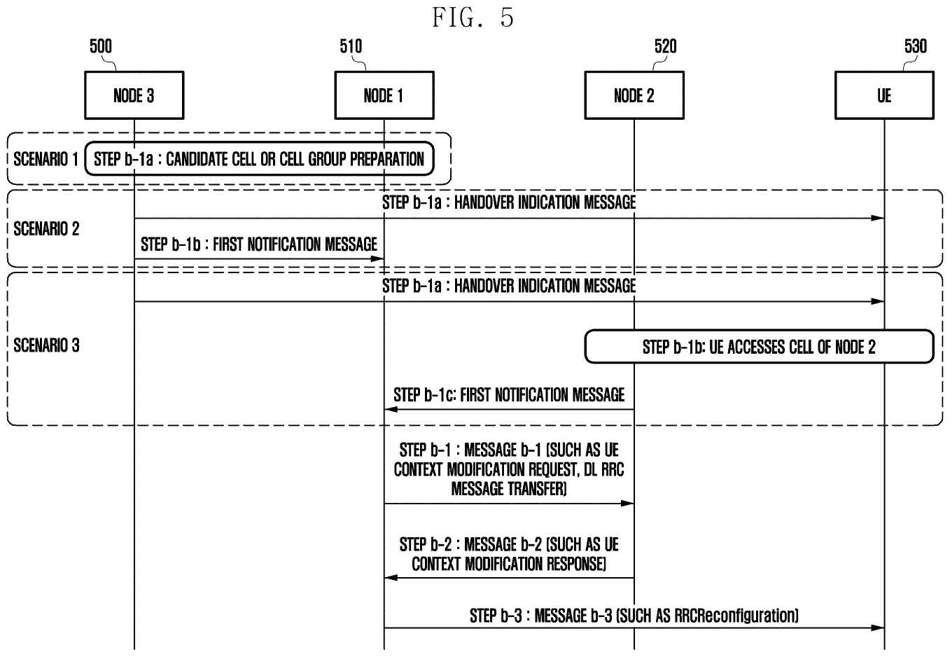

Referring to FIG. 5, this implementation may include the following process:
Step b-1: the node 1 510 transmits a message b-1 to the node 2 520; for this message, please refer to the first configuration message in the above step 1-1; and the message may include at least one of the following information:
First request indication information. After receiving the information, the node 2 520 will configure the candidate cell or cell group of the user equipment. See the description in the above step 1-1
First configuration indication information. After receiving the information, the node 2 520 will know the selected (or prepare to be configured, or already configured) candidate cell or cell group, and then node 2 520 is helped to select the target cell for handover. See the description in the above step 1-1
Configuration information of the user equipment 530, such as a container containing the RRCReconfiguration message
Step b-2: optionally, the node 2 520 transmits a message b-2 to the node 1510 ; for the message, please refer to the first configuration response message in the above step 1-2; a main function of this message is to transmit the configuration of the serving cell and/or the configuration of the candidate cell and/or the configuration for measuring the candidate cell or cell group generated by the node 2 520 to the node 1 510. After receiving the information, the node 1 510 will use it to configure the user equipment 530. The message may include at least one of the following information:
First response indication information, which mainly includes the configuration information of the candidate cell or cell group at the node 2 520 (such as the above “third cell configuration information”), or the configuration information of the current serving cell (such as the above “third serving cell configuration information”), or the measurement configuration information of the current serving cell (such as the above “third measurement configuration indication information”, which mainly configures the measurement of candidate cells and/or cell groups). See the description of the above step 1-2
Fourth measurement configuration indication information, which mainly includes the measurement configuration generated by the node 2 520 according to the selected (or prepare to be configured, or already configured) candidate cell or cell group provided by node 1 510, see the description in the above step 1-2
Step b-3: the node 1 510 (or the node 2 520) transmits a message b-3 to the user equipment 530. A purpose of this message is to update the configuration of the current serving cell and/or configure candidate cells for the user equipment, as described in the above “first user configuration message”.

When the node 1 510 and the node 2 520 are respectively the central unit of the base station (or the control plane portion of the central unit) and the distributed unit of the base station, in an example, the above process may only include step b-1 and step b-3, such as the message b-1 is a DL RRC Message Transfer message, and the message b-3 is that the distributed unit of the base station transmits the RRCReconfiguration message contained in the “configuration information of the user equipment” received in step b-1 to the user equipment 530; in another example, the above message b-1, message b-2 and message b-3 may be respectively a UE Context modification request (a F1 interface message), a UE Context modification response (a F1 interface message), RRCReconfiguration (an RRC message), or a newly-defined message, and the message b-3 may be transmitted by the node 1 510 to the node 2 520 through a DL RRC Message Transfer message, and then transmitted by the node 2 520 to the user equipment 530.

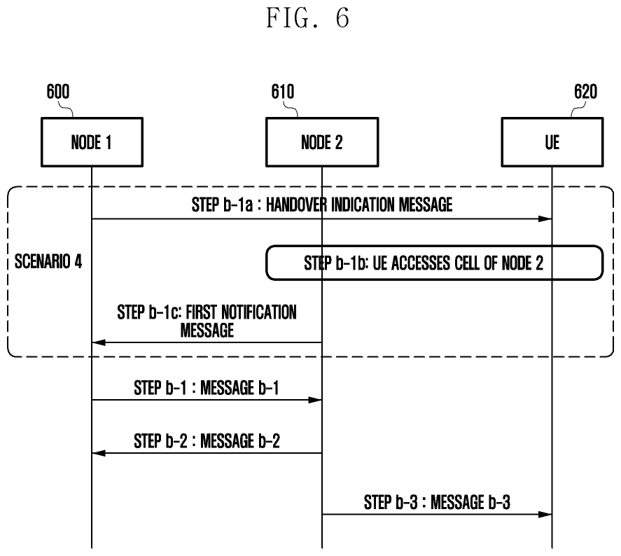

According to different scenarios, before the above step b-1 the following possible steps may also be included, as shown in FIG. 5 and/or FIG. 6:
Scenario 1: when the node 1 510 and the node 2 520 are respectively the central unit (or the control plane portion of the central unit) and the distributed unit of the base station where the current serving cell of the user equipment 530 (the user equipment has accessed the serving cell for a long time) is located, the following step may also be included before the above step b-1:
Step b-1a: the node 1 510 and one or more nodes 3 500 (such as distributed units different from the node 2 520, or other base stations or central units of the other base stations, or the control plane portions of central units of the other base stations) conduct candidate cell or cell group preparation. For the signaling interaction of the preparation process, please refer to the above steps 1-1 to 1-2. After node 1 510 obtains selectable candidate cells or cell groups from other nodes (such as the one or more nodes 3), the node 1 510 will select suitable candidate cell(s) or cell group(s) (e.g., based on capability of the user equipment 530 (such as the number of candidate cells or cell groups allowed to configure), the bearer of the user equipment 530 that can be admitted by the candidate cells or cell groups, and the load of the candidate cells or cell groups, etc.), and then proceed to the above steps b-1 to b-3. In addition, after the node 1 510 selects the suitable candidate cell(s) or cell group(s), there is also included that the node 1 510 and one or more nodes 3 500 (such as distributed units different from the node 2 520, or other base stations or central units of the other base stations, or the control plane portions of central units of the other base stations) conduct update of the configuration of the candidate cell(s), for example, the node 1 510 transmits the “first configuration indication information” (the information includes configuration related to one or more candidate cells selected by the first node, such as “second bearer configuration indication information”, “second cell configuration information”, etc. For details, see the description of the “first configuration indication information” in the above step 1-1) to the one or more nodes 3 according to step 1-1, and the one or more nodes 3 500 update the configuration (such as measurement configuration, see the above “measurement configuration information”) of the candidate cell(s) according to the received information
Scenario 2: after the candidate cell or cell group of the user equipment 530 has been configured for the user equipment 530, if the node 1 510 and the node 3 500 are respectively the central unit of the base station (or the control plane portion of the central unit) and the distributed unit of the base station where the current serving cell (the user equipment 530 has accessed the serving cell for a long time) is located, and the node 2 520 in scenario 2 is the distributed unit where the target cell is located, the following steps may also be included before the above step b-1:
Step b-1a: the node 3 500 transmits a handover indication message to the user equipment 530, which instructs the user equipment 530 to hand over to a target cell. See the above step 1-4
Step b-1b: the node 3 500 transmits a first notification message to the node 1 510, and the message is to notify the node 1 510 of the target cell for the handover of the user equipment 530 or the configuration of the target cell. In one example, this step may occur after the node 3 500 transmits the handover indication message to the user equipment 530. In another example, this step may occur after receiving the ac-knowledgment signalling (such as HARQ ACK signalling) transmitted by the user equipment 530 to the node 3 500 that the handover indication message has been correctly received. Through this step, the node 1 510 can know that the user equipment 530 is performing handover, so that it can select a suitable candidate cell or cell group according to the target cell of the user equipment 530, and then perform the above steps b-1 to b-3
Scenario 3: after the candidate cell or cell group of the user equipment 530 has been configured for the user equipment 530, if the node 1 510 and the node 2 520 are respectively the central unit (or the control plane portion of the central unit) of the base station and the distributed unit of the base station where the current serving cell (the user equipment has just accessed the cell) is located, the node 3 500 is the distributed unit of the base station where a source cell accessed by the user equipment 530 before the handover is located, then the following steps may also be included before the above step b-1:
Step b-1a: the node 3 500 transmits a handover indication message to the user equipment 530, which instructs the user equipment 530 to hand over to a target cell (for example, the distributed unit of the base station where the target cell is located is the node 2 520). See the above step 1-4 Step b-1b: the user equipment 530 accesses the cell of the node 2, such as the target cell indicated by the node 3 500 Step b-1c: optionally, the node 2 520 transmits the first notification message (such as the ACCESS SUCCESS message of F1 interface) to the node 1 510. This message is used to notify node 1 510 of the cell that the user equipment 530 has accessed. After that, node 1 510 can select a suitable candidate cell or cell group according to the cell accessed by the user equipment 530, and then perform the above steps b-1 to b-3 When the node 1 510 and the node 2 520 are the first base station and the second base station respectively, the following possible steps may be included before the above step b-1, as shown in FIG. 6:
Scenario 4: when the node 2 610 is a base station (or a central unit of the base station, or a control plane portion of the central unit of the base station) where the current serving cell of the user equipment 620 (the user equipment has just accessed the cell) is located, the node 1 600 is a base station (or a central unit of the base station, or a control plane portion of the central unit of the base station) where the cell that the user equipment 620 was connected to before accessing the node 2 610 is located, and the following steps are included before the above step b-1:
Step b-1a: the node 1 600 transmits a handover indication message to the user equipment 620, which instructs the user equipment 620 to hand over to a target cell, see the above step 1-4
Step b-1b: the user equipment 620 accesses the cell of the node 2 610
Step b-1c: optionally, the node 2 610 transmits a first notification message to the node 1 600, which is used to notify the node 1 600 of the cell accessed by the user equipment 620. After that, the node 1 600 can select a suitable candidate cell or cell group according to the cell accessed by the user equipment 620, and then perform the above steps b-1 to b-3

Through the above steps 1-3, the first network node will configure one or more candidate cells for the first node to perform handover, and then the first network node can indicate the first node to perform continuous handover (the handover can be a normal handover, or L1/L2 triggered mobility), which thus can avoid reconfiguration of the first node during the above continuous handover process, thereby reducing signalling overhead. However, in this process, due to the difference in the bearers admitted by these candidate cells, a bearer released in one cell may be configured in another cell. For example, the first network node configures three candidate cells, such as cell 1, cell 2 and cell 3, for the first node. The bearers admitted by the three cells are bearers 1-3, bearers 1-2, and bearers 1-3 respectively. The order in which the first node performs handover is: handover to the cell 1 first, then to the cell 2, and finally to the cell 3. In this process, when the first node hands over to the cell 2, because the cell 2only admits the bearers 1-2, the first node needs to release the bearer 3, so the service served by the bearer 3 may be interrupted, and the user may even exit from the service on the bearer 3. Then, when the first node hands over to the cell 3, the configuration of the cell will include the configuration of the bearer 3, but the service on the bearer 3 is released by the first node, which will cause waste of resources after the first node enters the cell 3 (for example, resources required by the first node to maintain the bearer 3 in the cell 3), as well as waste of resources in the cell 3 (the cell 3 allocates resources for serving the bearer 3). Therefore, due to the difference in the bearers admitted by different candidate cells, the resources of the cells may be wasted during the continuous handover of the first node. The present disclosure also proposes a method to solve this problem.

### Method 1: The User and the Base Station Release Autonomously

On the user side, the user will determine whether there is any bearer that needs to be released according to the bearer configuration in the cell (the source cell) before the handover and the bearer configuration in the cell (the target cell) after the handover. When the first node finds that the bearer configured by the source cell (this information can be obtained through the “first candidate cell configuration information” in the above “third message”) and the bearer configured by the target cell (this information can be obtained through the “first candidate cell configuration information” in the above “third message”) are different, the first node will update the bearer admitted in the target cell according to the bearer admitted in the source cell; if the bearer admitted in the target cell (i.e., the bearer configured in the configuration of the target cell) has been released in the source cell, then the first node will also release the bearer in the target cell. After receiving the above “third message”, the first node will store the configuration of each candidate cell (including the information of the bearer admitted in each candidate cell) included in the “third message”, so that the first node enables the configuration corresponding to the cell after handover to the corresponding cell. When the first node receives an indication to trigger the handover, if the first node finds that a first bearer (e.g., the bearer ID) included in the configuration of the target cell is not included in the configuration of the cell (the source cell) where the first node is located when the handover procedure is triggered, the first node will have at least one of following behaviours:
Behaviour 1: release the first bearer. Further, the first node will release the configuration related to the first bearer, such as the configuration of the RLC entity, the configuration of the PDCP entity, the configuration of the logical channel, etc.
Behaviour 2: update configuration information of other candidate nodes stored by the first node, for example, delete the configuration related to the first bearer (such as the configuration of the RLC entity, the configuration of the PDCP entity, the configuration of the logical channel, etc) in the configuration information of the other candidate nodes.

On the network side, if the first network node and the second network node serve the target cell of the first node, when the first network node learns that the first bearer configured by the first node in the target cell is not configured in the source cell, the first network node will notify the second network node to release the configuration of the first bearer.

### Method 2: The Bearer is Suspended

In this method, the above third message will indicate the suspended bearer in each candidate cell, and in an example, the suspended bearer is a bearer that cannot be admitted in the corresponding candidate cell. When a suspended bearer (the first bearer) is indicated in the configuration of the target cell (a first target cell) handed over by the first node, the first node will stop data transmission on the bearer, and further, will suspend the configuration corresponding to the bearer (such as the configuration of the PDCP, the configuration of the RLC, and the configuration of the logical channel), and clear data of the bearer in the cache. When the first node is handed over from the first target cell to another cell (a second target cell), if the suspended bearer (the first bearer) in the first target cell is admitted in the second target cell, then the first node will restart the data transmission on the first bearer according to the configuration information of the second target cell after entering the second target cell, and enable the configuration related to the bearer, such as the configuration of the PDCP entity, the configuration of the RLC entity, the configuration of the logical channel, etc. Further, in the above third message, for each suspended bearer, if “suspension time indication information” is also configured, then when the suspended bearer is suspended for a duration longer than the time length indicated by the indication information (that is, the suspended bearer does not resume data transmission within the time indicated by the indication information), the first node will release the first bearer and related configurations (such as the configuration of the PDCP entity, the configuration of the RLC entity, the configuration of the logical channel, etc). Further, the first node will update the configuration information of other candidate nodes stored by the first node (such as the above-mentioned “first stored configuration information”, “second stored configuration information”), e.g., delete the configuration related to the bearer (such as the configuration of the RLC entity, the configuration of the PDCP entity, the configuration of the logical channel, etc) in the configuration information of other candidate nodes.

### Method 3: The Network Indicates Release Through Configuration

In this method, the first network node is a node serving the target cell of the first node. When it finds that a bearer (the first bearer) has been released in the source cell of the first node, but is still configured in the target cell, the first network node will send a first user reconfiguration message to the first node. The message will contain at least one of following information:
Identity information of the released bearer, which indicates the bearer that needs to be released
Identity information of the associated cell, which indicates the cell that needs to release the bearer indicated by the above “identity information of the released bearer”
Identity information of association configuration, which indicates that the first node needs to release the configuration of the bearer indicated by the above “identity information of the released bearer” contained in the configuration indicated by the information (such as the configuration of the PDCP entity, the configuration of the RLC entity, the configuration of the logical channel, etc)

After the first node receives the above first user reconfiguration message, the first node will update the configuration in its “first stored configuration information” and/or “second stored configuration information” according to the configuration. In one example, the first node will release the bearer in the corresponding cell according to the above “identity information of the released bearer” and “identity information of the associated cell”; in another example, the first node will release the bearer in the corresponding cell according to the above “identity information of the released bearer” and “identity information of association configuration”.

Beneficial effects of the above three methods are that the first network node 300 or the first node 320 can release the bearer in the candidate cell in time, release resources, and improve resource utilization efficiency.

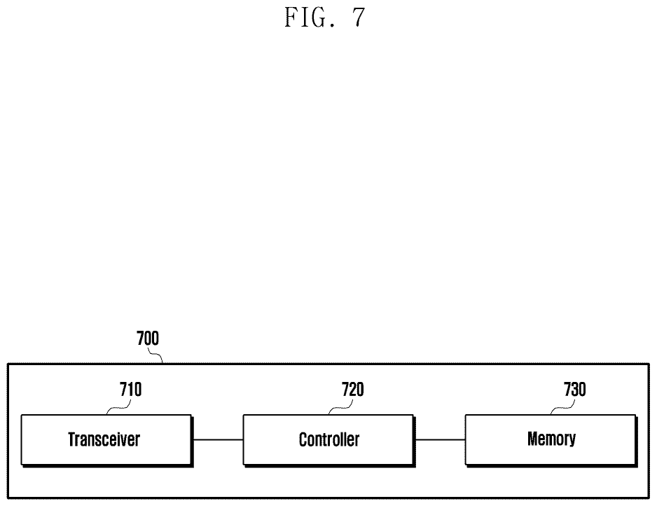

FIG. 7 is a block diagram of a node according to an exemplary embodiment of the present disclosure. Here, a node is taken as an example to illustrate its structure and function. However, it should be understood that the structure and function shown can also be applied to a base station (or a central unit of the base station, or a control plane portion of the central unit of the base station, or a user plane portion of the central unit of the base station, or a distributed unit of the base station, or a network node, etc.).

Referring to FIG. 7, a node 700 includes a transceiver 710, a controller 720, and a memory 730. Under the control of the controller 720 (which may be implemented as one or more processors), the node 700 (including the transceiver 710 and the memory 730) is configured to perform the operations of the node described herein. Although shown as separate entities, the transceiver 710, the controller 720, and the memory 730 may be implemented as a single entity, such as a single chip. The transceiver 710, the controller 720, and the memory 730 may be electrically connected or coupled to each other. The transceiver 710 may transmit a signal to and receive a signal from other network entities, such as another node and/or a UE, etc. In one implementation, the transceiver 710 may be omitted. In this case, the controller 720 may be configured to execute instructions (including computer programs) stored in the memory 730 to control the overall operation of the node 700, thereby implementing the operations of the node described herein.

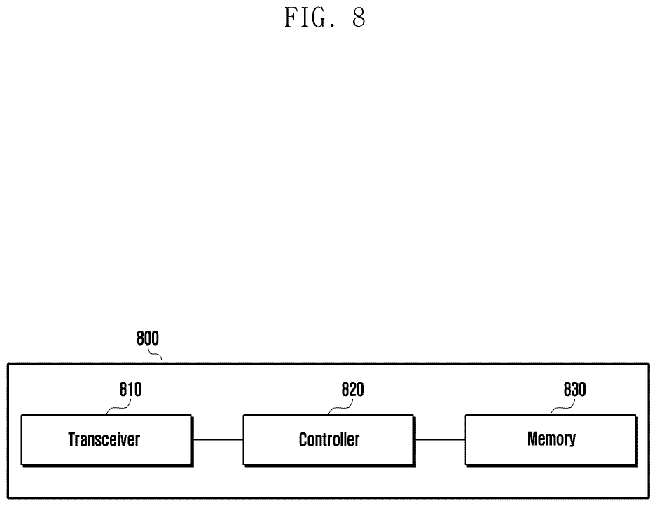

FIG. 8 is a block diagram of a user equipment according to an exemplary embodiment of the present disclosure.

Referring to FIG. 8, a user equipment 800 includes a transceiver 810, a controller 820, and a memory 830. Under the control of the controller 820 (which may be implemented as one or more processors), the user equipment 800 (including the transceiver 810 and the memory 830) is configured to perform the operations of the user equipment described herein. Although shown as separate entities, the transceiver 810, controller 820, and memory 830 may be implemented as a single entity, such as a single chip. The transceiver 810, the controller 820, and the memory 830 may be electrically connected or coupled to each other. The transceiver 810 may transmit a signal to and receive a signal from other network entities, such as a node, another UE, or the like. In one implementation, the transceiver 810 may be omitted. In this case, the controller 820 may be configured to execute instructions (including computer programs) stored in the memory 830 to control the overall operation of the user equipment 800, thereby performing the operations of the user equipment described herein.

According to some implementations, the memory 730 and/or 830 of the present disclosure may include a non-transitory computer-readable medium storing one or more instructions for communication. The one or more instructions, when executed by the controller 720 and/or 820, cause the node 700 and/or the user equipment 800 to perform various operations in the methods of the node and/or the user equipment described herein.

According to some implementations, the user equipment described in the present disclosure may include: a cellular or other communication device having a single-line display or a multi-line display, or a cellular or other communication device without a multi-line display; Personal Communications Service (PCS), which may combine voice, data processing, facsimile and/or data communication capabilities; Personal Digital Assistant (PDA), which may include a radio frequency receiver, a pager, Internet/Intranet access, a web browser, a notepad, a calendar and/or a Global Positioning System (GPS) receiver; a conventional laptop and/or palmtop computer or other device having and/or including a radio frequency receiver. The “terminal” and “terminal device” as used herein may be portable, transportable, installed in a vehicle (aeronautical, maritime and/or terrestrial), or adapted and/or configured to operate locally, and/or to operate at any other location on earth and/or in space, in a distributed form. The “terminal” and “terminal device” used here may also be a communication terminal, an Internet terminal, a music/video player terminal, such as a PDA, Mobile Internet Device (MID), and/or a mobile phone with music/video playback functions, or may be devices such as a smart TV, a set-top box, etc.

Those skilled in the art may realize that the present disclosure can be implemented in other specific forms without changing the technical idea or basic features of the present disclosure. Therefore, it should be understood that the above-mentioned embodiments are merely examples and not limitative. The scope of the present disclosure is defined by the appended claims rather than the detailed description. Therefore, it should be understood that all modifications or changes derived from the meaning and scope of the appended claims and their equivalents fall within the scope of the present disclosure.

In the above-described embodiments of the present disclosure, all operations and messages may be selectively performed or may be omitted. In addition, the operations in each embodiment do not need to be performed sequentially, and the order of operations may vary. Messages do not need to be transmitted in order, and the transmission order of messages may vary. Each operation and transfer of each message can be performed independently.

Although the present disclosure has been illustrated and described with reference to various embodiments of the present disclosure, those skilled in the art will understand that various changes can be made in form and detail without departing from the spirit and scope of the present disclosure as defined by the appended claims and their equivalents.

1.-15. (canceled)

16. A method performed by a central unit (CU) of a base station, the method comprising:
transmitting, to a candidate distributed unit (DU), a first request message associated with at least one candidate cell for a layer 1/layer 2 (L1/L2) triggered mobility (LTM);
receiving, from the candidate DU, a second response message including first information associated with an accepted candidate cell;
transmitting, to a source DU, a third request message including second information associated with the accepted candidate cell; and
transmitting, to the source DU, a radio resource control (RRC) reconfiguration message including LTM configuration information, the RRC reconfiguration message is forwarded to a terminal.

17. The method of claim 16, wherein the LTM configuration information includes configuration information on at least one candidate cell, and LTM reference configuration information.

18. The method of claim 17, wherein complete configuration information of a candidate cell is generated and stored by the terminal based on the configuration information on at least one candidate cell, and the LTM reference configuration information.

19. The method of claim 16, wherein a first request message further includes at least one an LTM indicator, a cell identity of the candidate cell, reference configuration information for generating cell group configuration for the terminal, or channel state information (CSI) resource configuration information.

20. The method of claim 16, wherein the second response message further includes at least one a cell identity of the accepted candidate cell, transmission configuration indicator (TCI) states configuration information, or synchronization signal block (SSB) configuration information.

21. The method of claim 16, wherein the third request message further at least one channel state information (CSI) resource configuration information, a cell identity of the accepted candidate cell, or transmission configuration indicator (TCI) states configuration information.

22. The method of claim 17, wherein the configuration information on the at least one candidate cell further includes LTM candidate configuration information in an RRC reconfiguration message for a candidate cell.

23. The method of claim 17, wherein the LTM reference configuration information includes configuration information in an RRC reconfiguration message.

24. A central unit (CU) of a base station, the CU comprising:
a transceiver configured to transmit and receive a signal; and
at least one processor, coupled to the transceiver and configured to:
transmit, to a candidate distributed unit (DU) via the transceiver, a first request message associated with at least one candidate cell for a layer 1/layer 2 (L1/L2) triggered mobility (LTM),
receive, from the candidate DU via the transceiver, a second response message including first information associated with an accepted candidate cell,
transmit, to a source DU via the transceiver, a third request message including second information associated with the accepted candidate cell, and
transmit, to the source DU via the transceiver, a radio resource control (RRC) reconfiguration message including LTM configuration information, the RRC reconfiguration message is forwarded to a terminal.

25. The CU of claim 24, wherein the LTM configuration information includes configuration information on at least one candidate cell, and LTM reference configuration information.

26. The CU of claim 25, wherein complete configuration information of a candidate cell is generated and stored by the terminal based on the configuration information on at least one candidate cell, and the LTM reference configuration information.

27. The CU of claim 24, wherein a first request message further includes at least one an LTM indicator, a cell identity of the candidate cell, reference configuration information for generating cell group configuration for the terminal, or channel state information (CSI) resource configuration information.

28. The CU of claim 24, wherein the second response message further includes at least one a cell identity of the accepted candidate cell, transmission configuration indicator (TCI) states configuration information, or synchronization signal block (SSB) configuration information.

29. The CU of claim 24, wherein the third request message further at least one channel state information (CSI) resource configuration information, a cell identity of the accepted candidate cell, or transmission configuration indicator (TCI) states configuration information.

30. The CU of claim 25, wherein the configuration information on the at least one candidate cell further includes LTM candidate configuration information in an RRC reconfiguration message for a candidate cell.

31. The CU of claim 25, wherein the LTM reference configuration information includes configuration information in an RRC reconfiguration message.
